(19) United States
(12) Patent Application Publication
(10) Pub. No.: US 2012/0331385 A1
(43) Pub. Date: Dec. 27, 2012

(54) ASYNCHRONISTIC PLATFORM FOR REAL TIME COLLABORATION AND CONNECTION

(76) Inventors: Brian Andreas, Santa Barbara, CA (US); Zane Jacobson, Lake Oswego, OR (US); Renato Untalan, Santa Barbara, CA (US); David Parker, Santa Barbara, CA (US); Ian Butler, Santa Barbara, CA (US)

(21) Appl. No.: 13/476,983

(22) Filed: May 21, 2012

Related U.S. Application Data
(60) Provisional application No. 61/488,695, filed on May 20, 2011.

(51) Int. Cl. G06F 15/16; G06F 17/30; G06F 3/01

(52) U.S. Cl. 715/716

(57) ABSTRACT

A method of authoring a multimedia presentation includes: receiving a command, over a network connection, to add a first media object having a first start time to the presentation, the first media object being stored in a data store; storing a first start time and an identifier of the first media object in a presentation description of the multimedia presentation, the presentation description being stored in a database; receiving a command, over the network connection, to add a second media object having a second start time to the presentation, the second media object being stored in the data store; and storing a second start time and an identifier of the second media object in the presentation description.

### CROSS-REFERENCE TO RELATED APPLICATION(S)

This application claims the benefit of U.S. Provisional Patent Application No. 61/448,695 “Asynchronistic Platform for Real Time Collaboration and Connection,” filed in the United States Patent and Trademark Office on May 20, 2011.

### BACKGROUND

In the field of online multimedia communications, the wide variety of end user devices, file formats, and other constraints may impede the collaborative creation and sharing of multimedia presentations (e.g., audio and video slideshows and movies).

In addition, current online media display systems are generally linear and do not allow content creators to provide additional details and digressions in context while maintaining the originally intended flow of the presentation.

### SUMMARY

Embodiments of the present invention are directed to systems and methods for creating multimedia presentations and sharing these multimedia presentations with others. In some embodiments, these multimedia presentations allow the content creators to define “branches” which allow the exploration of side stories and side notes without losing their place within the presentation.

According to one embodiment, a system for generating multimedia presentations includes: a database; a data store; and a server connected to the database and the data store, the server being configured to: store a plurality of media objects in the data store; store a description of a multimedia presentation in the database, the multimedia presentation being associated with one or more of the media objects; receive user inputs related to timing and position of the media objects associated with the multimedia presentation, the user inputs being received over a network connection; and modify the description of the multimedia presentation based on the user inputs.

According to another embodiment of the present invention, a method of authoring a multimedia presentation includes: receiving a command to add a first media object having a first start time to the presentation; storing a first start time and an identifier of the first media object in a description of the multimedia presentation; receiving a command to add a media object having a second start time to the presentation; and storing a second start time and an identifier of the second media object in the description.

According to one embodiment of the present invention, a system for creating and playing a multimedia presentation includes: a database; a data store; and a server connected to the database and the data store, the server being configured to: store a plurality of media objects in the data store, each of the media objects being associated with a media object identifier of a plurality of media object identifiers, each media object identifier being unique; store a plurality of stacks in the database, each of the stacks comprising a set of one or more media object identifiers selected from the plurality of media object identifiers; store a presentation description of the multimedia presentation in the database, the presentation description comprising a set of one or more media object identifiers selected from the plurality of media object identifiers, each media object identifier of the set of one or more media object identifiers being associated with metadata, the metadata comprising timing and position information; receive user inputs related to timing and position of the media objects associated with the multimedia presentation, the user inputs being received over a network connection; and store the received user inputs in the presentation description of the multimedia presentation.

The server may be further configured to: receive a request to play the multimedia presentation over the network connection; retrieve the presentation description of the multimedia presentation from the database; retrieve, from the data store, the media objects associated with the media object identifiers in the set of one or more media object identifiers associated with the presentation description; and transmit, over the network connection, the plurality of retrieved media objects.

The server may be further configured to: receive a request to add a media object identifier from a stack of the stacks to the multimedia presentation; transcode a portion of a media object associated with the media object identifier; and transmit the transcoded portion of the media object over the network connection when the transcoding is complete.

The system may further include a client connected to the server over the network connection, the client including a network interface, a processor, and a display, the client being configured to: receive the plurality of retrieved media objects over the network connection; transcode the portion of the media object associated with the media object identifier when the transcoding of the portion of the media object on the server is incomplete; and display the retrieved media objects and the transcoded portion of the media object on the display.

The presentation description may further include a branch description associated with a branch, the branch description including a branch set of one or more media object identifiers selected from the plurality of media object identifiers, each media object identifier of the branch set of one or more media object identifiers being associated with metadata, the metadata including timing and position information, and wherein the server may be further configured to: receive a request to play a branch; retrieve, from the data store, the media objects associated with the media object identifiers in the branch set of one or more media object identifiers associated with the branch description; and transmit, over the network connection, the plurality of retrieved media objects associated with the branch.

The server may be further configured to: store one or more playlists associated with a stack of the stacks in the database, each of the playlists including a list of one or more media object identifiers selected from the set of one or more media object identifiers associated with the stack; receive a request to play a playlist of the playlists over the network connection; retrieve the requested playlist from the database; retrieve, from the data store, a plurality of media objects associated with the media object identifiers in the list of one or more media object identifiers of the requested playlist; and transmit, over the network connection, the plurality of retrieved media objects.

According to another embodiment of the present invention, a method of authoring a multimedia presentation includes: receiving a command, over a network connection, to add a first media object having a first start time to the presentation, the first media object being stored in a data store; storing a first start time and an identifier of the first media object in a presentation description of the multimedia presentation, the presentation description being stored in a database; receiving a command, over the network connection, to add a second media object having a second start time to the presentation, the second media object being stored in the data store; and storing a second start time and an identifier of the second media object in the presentation description.

The method may further include: receiving a command, over the network connection, to adjust a length of the first media object; and storing an adjusted stop time of the first media object in the presentation description.

The method may further include: receiving a request to play the multimedia presentation over the network connection; retrieving the presentation description of the multimedia presentation from the database; retrieving, from the data store, the first media object and the second media object; and transmitting, over the network connection, the first media object and the second media object.

The method may further include: storing a plurality of stacks in the database, each of the stacks comprising a set of media object identifiers; receiving a request to add a third media object identifier from a stack of the stacks to the multimedia presentation; transcoding a portion of a third media object associated with the third media object identifier; and transmitting the transcoded portion of the third media object when the transcoding is complete.

The transcoding the portion of the third media object may be performed by a server, the method further including: transcoding, at a client coupled to the server, the portion of the third media object if the transcoding of the portion of the third media object by the server is incomplete; receiving, at the client, the transcoded portion of the third media object from the server if the transcoding of the portion of the third media object by the server is, complete; and displaying the transcoded portion of the third media object.

The presentation description may further include a branch description associated with a branch, and the method may further include: receiving a request to display a branch; retrieving, from the data store, a branch media object listed in the branch description; and transmitting the retriever branch media object over the network connection.

The method may further include: storing a plurality of stacks in the database, each of the stacks comprising a set of media object identifiers; storing one or more playlists associated with a stack of the stacks, each of the playlists comprising a list of one or more media object identifiers selected from the set of one or more media object identifiers associated with the stack; receiving a request to play a playlist of the playlists over the network connection; retrieving the requested playlist from the database; retrieving, from the data store, a plurality of media objects associated with the media object identifiers in the list of one or more media object identifiers of the requested playlist; and transmitting, over the network connection, the plurality of retrieved media objects.

According to another embodiment of the present invention, a method of playing back a multimedia presentation includes: receiving, from a server, a presentation description of a multimedia presentation associated with a first media object and a second media object, the second media object having a start time later than the first media object; requesting a first media object; receiving and playing back the first media object; and requesting the second media object after the start of the playing back of the first media object and before the start time of the second media object.

The presentation description may further include a branch object, the branch object being associated with a branch description comprising a reference to a third media object, and the method may further include: receiving a presentation description of a multimedia presentation associated with a first media object, a second media object, and a branch object, the second media object being associated with the branch object and the branch object having a start time later than and during the playing back of the first media object; requesting the first media object from a server; receiving and playing back the first media object; and at the start time of the branch object, displaying a control configured to allow a user to display the second media object.

The method may further include: receiving a command via the control to display the second media object; pausing the playing back of the multimedia presentation; and playing back the second media object.

The method may further include: adding a third media object to the multimedia presentation; initiating playback of the multimedia presentation; determining whether a portion of the third media object has been transcoded by a server; transcoding a portion of the third media object if the transcoding of the portion of the third media object by the server is incomplete; receiving the transcoded portion of the third media object from the server if the transcoding the portion of the third media object by the server is complete; and displaying the transcoded portion of the third media object.

The method may further include: selecting a stack from a plurality of stacks stored in a database, each of the stacks comprising a set of media object identifiers; selecting one or more media object identifiers from the set of media object identifiers of the selected stack; adding the selected one or more media object identifiers to a playlist, each of the object identifiers being associated with a start time in the playlist; and saving the playlist to the database.

The method may further include: requesting one or more media objects corresponding to the one or more media object identifiers of the playlist; and receiving a plurality of media objects associated with the media object identifiers of the requested playlist.

The method may further include: loading the playlist; modifying a start time of an object within the playlist; and saving the modified playlist.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram of a multimedia presentation system according to one embodiment of the present invention.

FIG. 2 is a functional block diagram illustrating components of the multimedia presentation system according to one embodiment of the present invention.

FIG. 3A is a screenshot of a user interface for creating multimedia presentations according to one embodiment of the present invention.

FIG. 3B is a screenshot of a workbench with a blank cloud according to one embodiment of the present invention.

FIG. 3C is a screenshot of a workbench containing a cloud containing a video clip according to one embodiment of the present invention.

FIG. 3D is a screenshot of a workbench containing a cloud containing a video clip and an audio clip according to one embodiment of the present invention.

FIG. 3E is a screenshot of a workspace showing a preview of a cloud containing a video clip and an audio clip according to one embodiment of the present invention.

FIG. 4 is a flowchart illustrating a method of processing content to be added to the multimedia presentation system according to one embodiment of the present invention.

FIG. 5 is a flowchart illustrating a method of processing video content to be added to the multimedia presentation system according to one embodiment of the present invention.

FIG. 6 is a flowchart illustrating a method of processing audio content to be added to the multimedia presentation system according to one embodiment of the present invention.

FIG. 7 is a flowchart illustrating a method of processing still image content to be added to the multimedia presentation system according to one embodiment of the present invention.

FIG. 8 is a flowchart illustrating a method of processing other content to be added to the multimedia presentation system according to one embodiment of the present invention.

FIG. 9 is a flowchart illustrating a method for adding a media object to a stack according to one embodiment of the present invention.

FIG. 10 is a flowchart illustrating a method for adding a media object from a stack onto a canvas.

FIGS. 11, 12, and 13 are flowcharts illustrating methods of manipulating the length, position, and meta-data of objects.

FIG. 14 is a flowchart illustrating a method of playing back a cloud according to one embodiment of the present invention.

FIG. 15 is a flowchart illustrating a method of playing back a branch according to one embodiment of the present invention.

FIG. 16 is a flowchart illustrating a method of implementing taxonomical and recursive searching according to one embodiment of the present invention.

FIG. 17 is a flowchart illustrating the method of preparing taxonomies according to one embodiment of the present invention.

FIG. 18 is a flowchart illustrating a method of playing back a cloud according to another embodiment of the present invention.

FIG. 19 is a flowchart illustrating a method of capturing a stream for playback according to one embodiment of the present invention.

FIG. 20 is a flowchart illustrating a method of rendering objects for playback in parallel on both a client and a server, according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Embodiments of the present invention are directed to a multimedia presentation and authoring system for creating presentations out of a variety of types of content objects (or “elements”) such as video, audio, text, web pages, RSS feeds, images, etc. This content can be drawn in from external websites and content management services such as Flickr, Picasa, YouTube, and Vimeo. These content objects can be assembled together into presentations (which may be referred to herein as “clouds” or “roughcuts”) which may be interlinked with one another and shared with other users.

In one embodiment, a free-form media workbench allows users to build multimedia presentations on an open canvas. Users can drag and drop objects of any length of time anywhere on the canvas to form a unique multimedia presentation. Users can move and place objects all over the workbench canvas. Users can stretch and compress objects to change their duration, as represented by start and end points. Users can pan around the canvas and zoom in and out. Users can play, pause, and replay the presentation at anytime while moving or reordering objects on the canvas. Users can preview single objects and manipulate the properties of objects.

The clouds may include objects such as video, photo, audio, text, documents, and place holders (which may be referred to herein as “wildcards”). These objects are dragged into containers (which may be referred to as “stacks”) which contain personal, shared, and public media objects which have been collected by the user and may also be dragged from the stacks onto the canvas.

In one implementation of the workbench, presentations begin playing from the beginning of the object furthest on the left side of the canvas (x-axis) regardless of its vertical position on the canvas (the y-axis). In these embodiments, this behavior is also independent of whether the canvas has been zoomed in and dragged to the side making the left most object not visible on the screen. Presentations play the canvas presentation from left to right, playing each object for its visible duration. Objects occupying the same location on the x-axis (e.g., spaced part along the same line extending in the y-axis) will play at the same time.

In some embodiments, the objects on the canvas and the objects themselves are all mapped to an extensible markup language (XML) document (or multiple XML documents) which describes all the information about the cloud and how to present the cloud as well as the location of the objects on the canvas. The player processes the XML document to play the presentation. In other embodiments of the present invention, the cloud may be represented using data formats other than XML, such as YAML and JavaScript Object Notation (JSON).

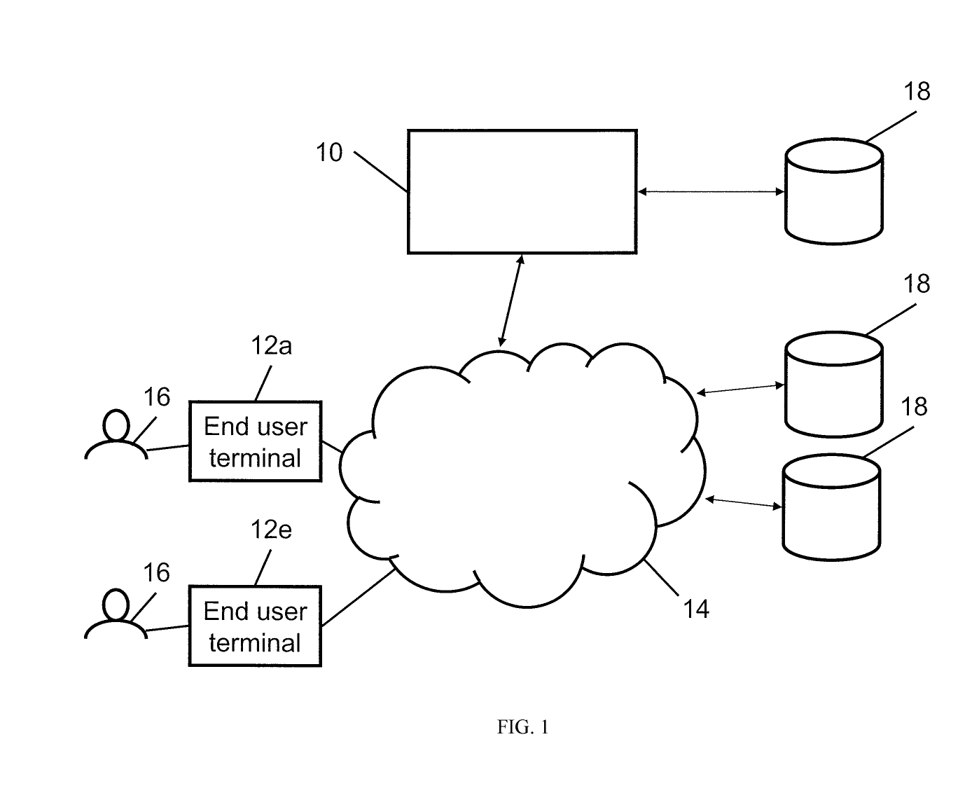

FIG. 1 is a schematic block diagram illustrating a multimedia presentation and authoring system according to one embodiment of the present invention which includes a server 10 configured to run software to receive input and data from users 16, to manipulate the data, and to store the data in a plurality of databases or data stores 18. Users 16 interact with the system via end user terminals 12 (e.g., 12a and 12e) which are connected to the server 10 via a computer network 14. The server 10 and the database 18 may be standard computers running any of a variety of operating systems, web servers, and databases (e.g., Linux, Apache, and MySQL). In addition, the server 10 and the database 18 may each include a plurality of computers such that the workload is distributed among the various computers. The end user terminals may be any of a variety of computing devices such as desktop and laptop computers running any of a variety of operating systems (such as Microsoft® Windows®, Mac OS X®, or Linux), a tablet computer (such as an Apple® iPad®), or a smartphone (such as an Apple® iPhone® or a phone running Google® Android®). The computer network 14 is a data communication network such as the Internet and the network may make use of a variety of standard wired and wireless communications protocols.

According to one embodiment of the present invention, a user 16 can create and view multimedia presentations using a web application running in a web browser such as Mozilla®Firefox®, Apple® Safari®, Google® Chrome®, Microsoft® Internet Explorer®, and Opera®. The web application may be hosted by the server 10 and, in one embodiment, is implemented using a variety of web technologies including HTML5, CSS, and Ajax.

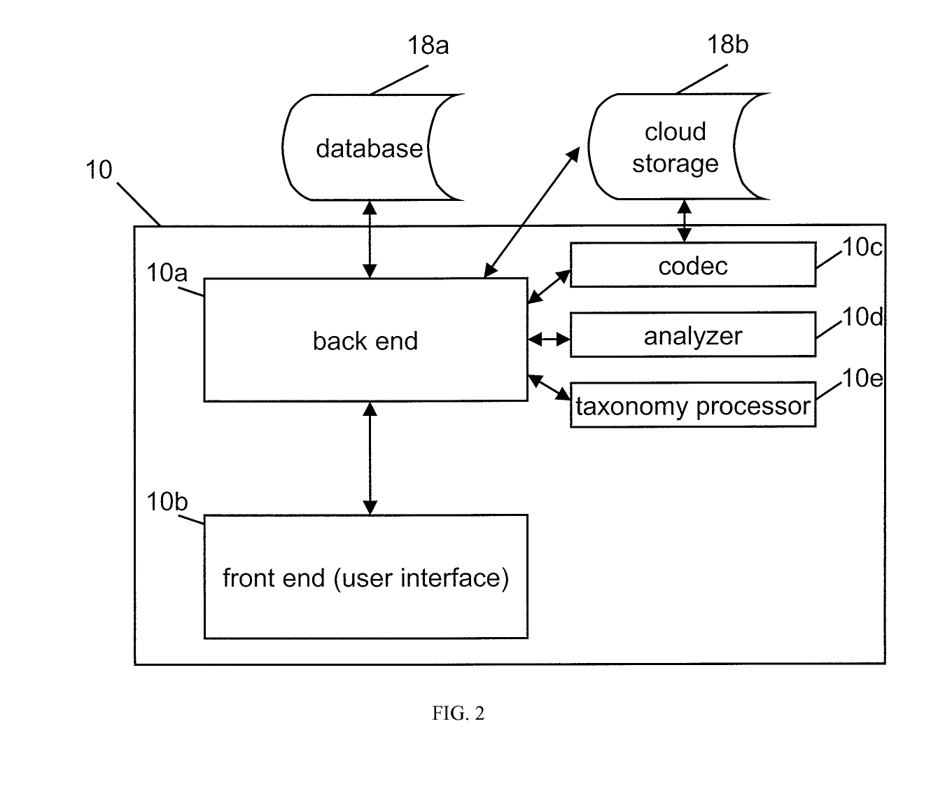

FIG. 2 is a functional block diagram illustrating components of the software components running on the server 10. The server includes a back end 10a coupled to databases 18, including a database 18a and a cloud storage (or “data store”) 18b, a front end (or user interface) 10b, a codec 10c, an analyzer 10d, and a taxonomy processor 10e. The codec 10c may be used for encoding and decoding the formats of data objects stored in the cloud storage 18b. The analyzer 10d may be used to analyze the content of the data objects, and the taxonomy processer 10e may be configured to provide taxonomical searching and browsing of the data objects stored in the cloud storage 18b.

As used herein, the term “server” broadly refers to one or more interconnected computer systems, each of which may be configured to provide different functionality. For example, the codec 10c, the analyzer 10d, and the taxonomy processor 10e may be implemented by processes running on the same or different physical hardware as the back end 10a. In addition, any of the components of the “server” may be spread across multiple physical or virtualized computers. For example, the codec 10c may include multiple computers configured to process the transcoding of data objects between formats.

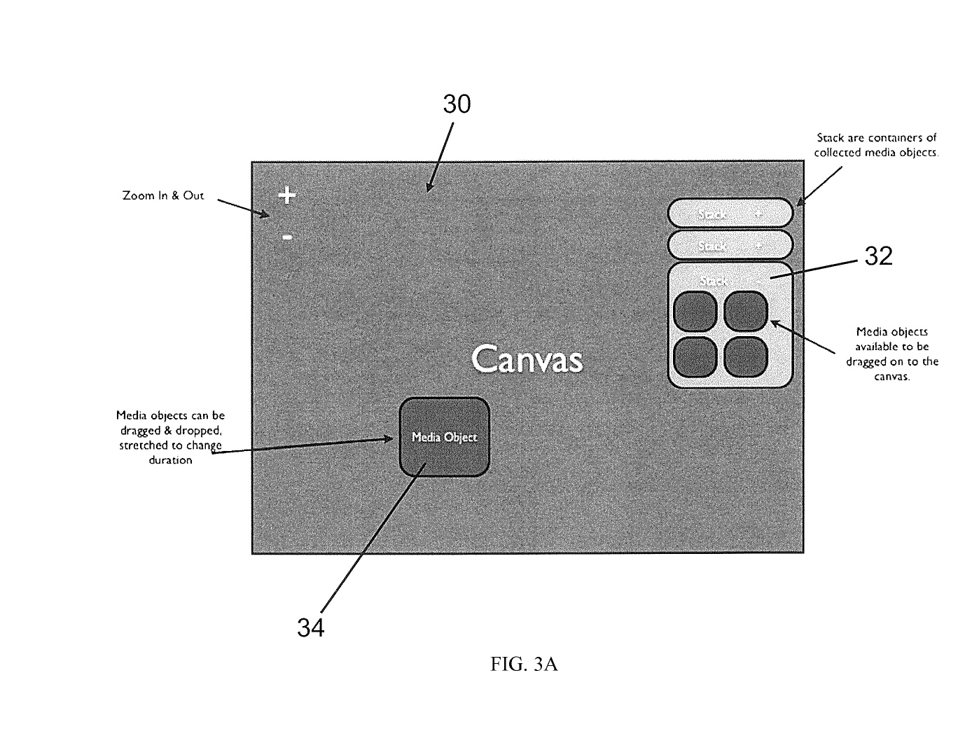

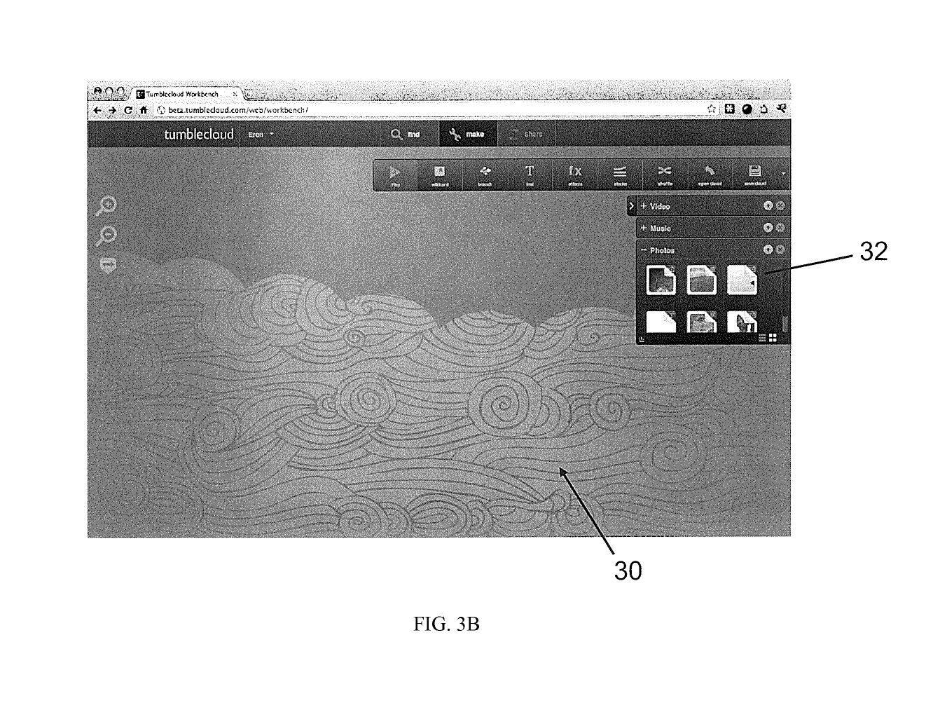

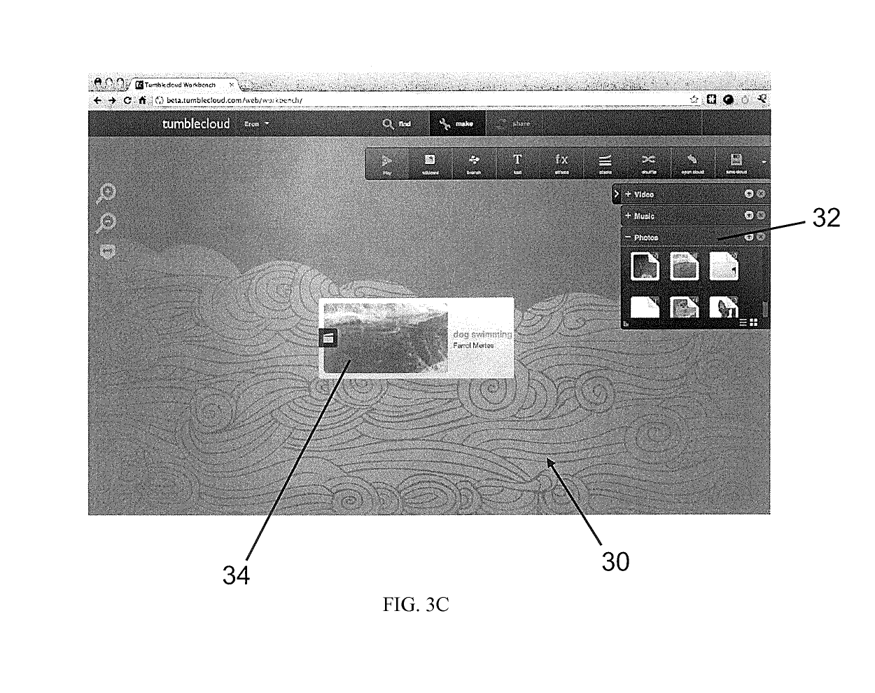

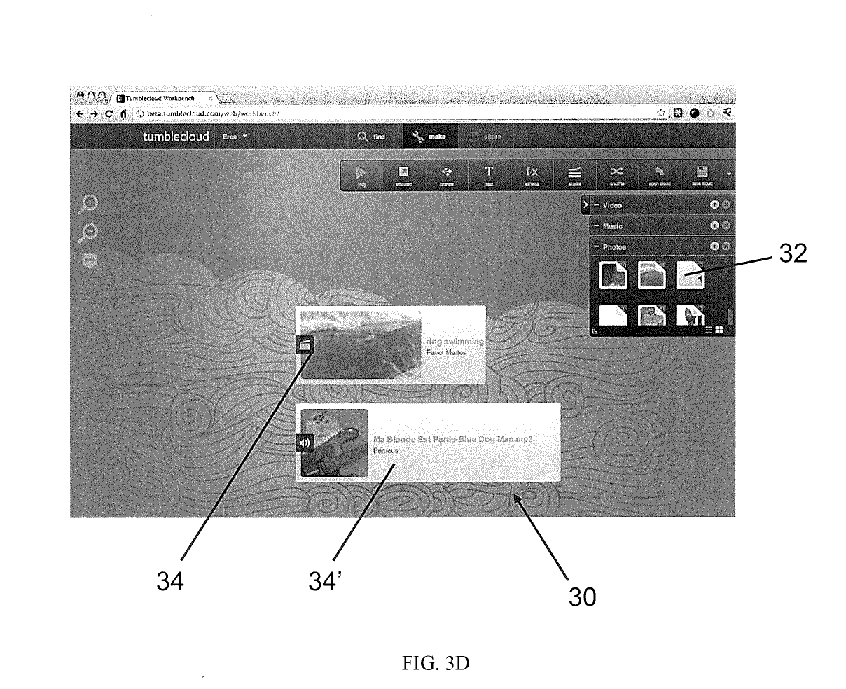

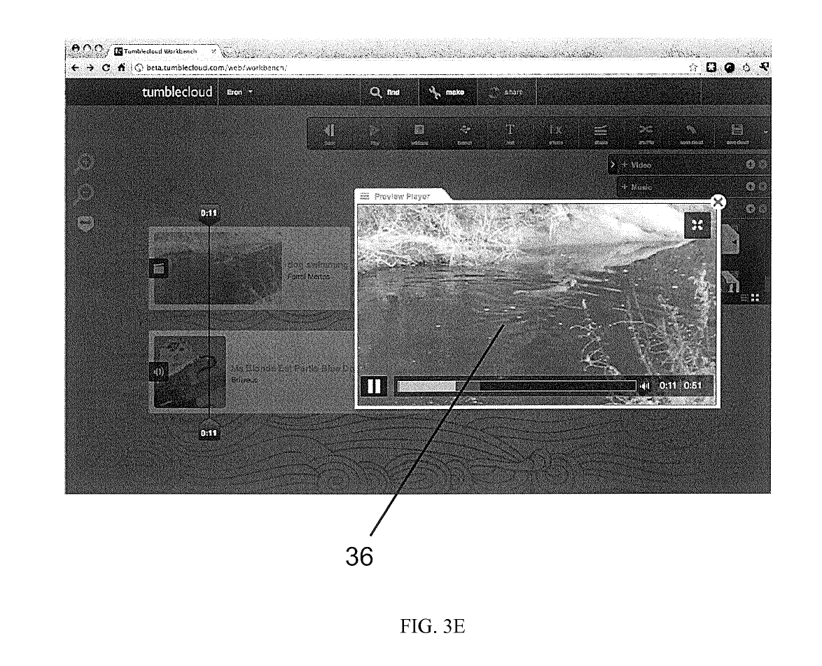

FIG. 3A is an abstract depiction of a user interface for authoring multimedia presentations (or “clouds”) according to one embodiment of the present invention. The user interface allows a user 16 to drag and drop media objects 34 from one or more stacks 32 onto a canvas 30. The media objects may represent items such as a video, a sound clip, an image, and text.

By arranging the media objects 34 at various locations along a first direction (e.g., along the horizontal axis of the canvas) the user 16 can control the order in which these media objects are presented during playback of the multimedia cloud. The user can modify the duration of the display of an individual object by adjusting its width on the canvas 30.

By arranging the media objects 34 at various locations along a second direction (e.g., along the vertical axis of the canvas), the user 16 can insert multiple media objects to be displayed or overlaid on one another. For example, a text object may be overlaid over a video or an image by dragging it to overlap with the video or image along the x-direction.

As such, by arranging various media objects on the canvas 30, a user can control when, where, and for how long various media objects are displayed during the playback of a cloud.

FIGS. 3B, 3C, 3D, and 3E are screenshots of a user interface according to one embodiment of the present invention. FIG. 3B is a screenshot of an empty canvas with a blank cloud and stacks 32 of media objects. FIG. 3C is a screenshot of a workbench with a cloud containing a media object 34 (in FIG. 3C, a video clip). FIG. 3D is a screenshot of a workbench containing a cloud containing two media objects—a video clip 34 and an audio clip 34′. FIG. 3E is a screenshot of a workspace showing a preview 36 of a cloud containing a video clip and an audio clip.

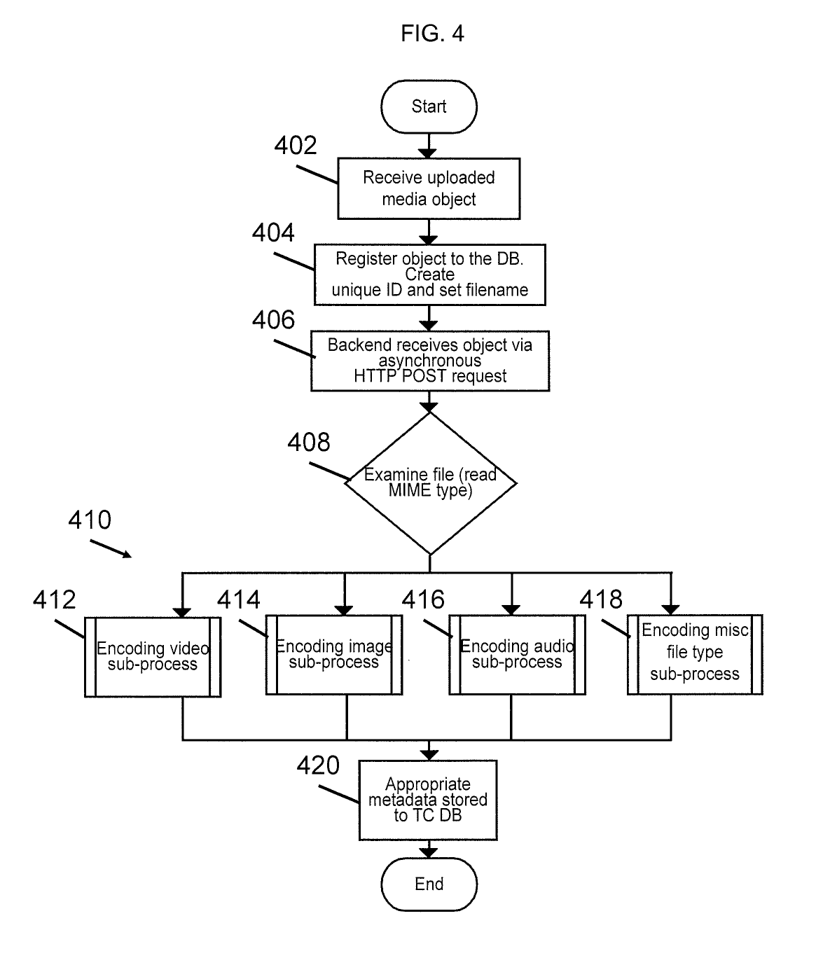

FIG. 4 is a flowchart illustrating a method by which the server 10 processes media objects submitted by a user according to one embodiment of the present invention. A user may upload a media file containing a video, an audio clip, an image, a document, etc. In other embodiments, a user may provide a URL to the media file they would like to add to the multimedia presentation system, or a URL of a feed containing links to media objects to be added. The server 10 receives (402) the uploaded media object and registers (404) the object to the cloud storage (or database) 18b. The backend 10a then receives (406) the object, e.g., via an asynchronous HTTP POST request. The received object is then examined (408) to determine its type, e.g., by analyzing the MIME metadata, and then encoded (410) in accordance with the determined type. For example, the data may be encoded by a video sub-process (412), an image sub-process (414), an audio sub-process (416), or a miscellaneous (or other) sub-process (418). The appropriate metadata associated with the data object and the object are then stored (418) in the databases 18 (e.g. database 18a and cloud storage 18b).

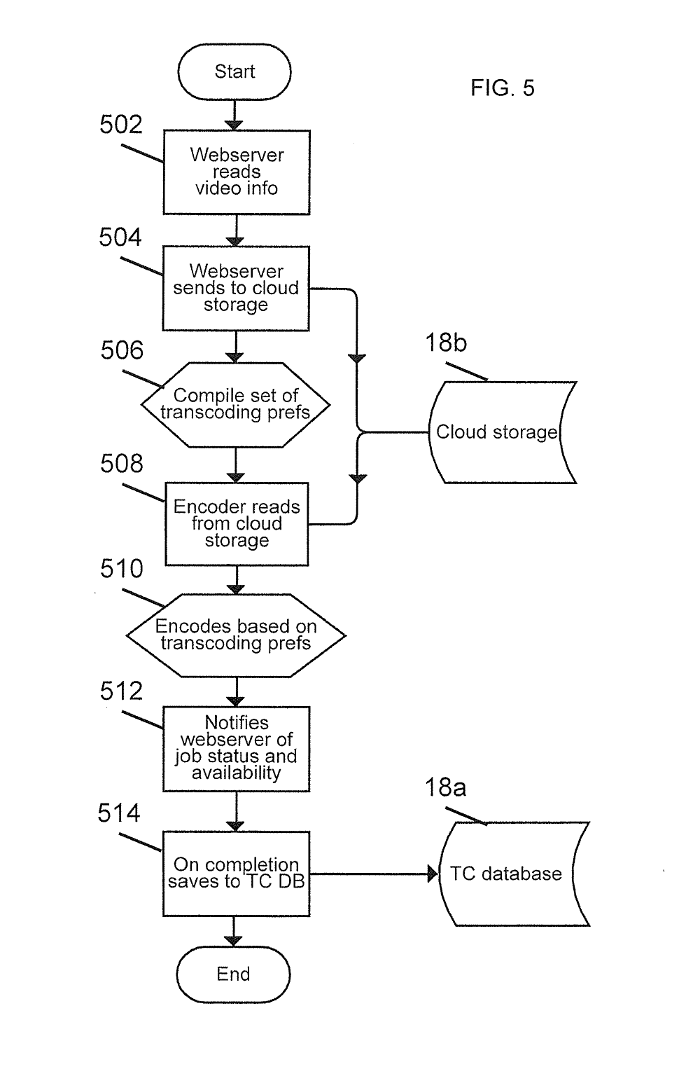

FIGS. 5, 6, 7, and 8 are flowcharts illustrating methods by which video, audio, image, and miscellaneous media types are added to the data store and database according to one embodiment of the present invention.

Referring to FIG. 5, according to one embodiment of the present invention, when processing a video object, the webserver first reads (502) the video information of the video object, then sends the video object to cloud storage 18b. The webserver may then compile a set of transcoding preferences (e.g., preferences set by a user or default settings of the application) such as output resolution, bitrate, and video encoding codec (e.g., x264, FFmpeg, Quicktime, WMV, VP8, etc.). The codec portion 10c of the server 10 then reads the object from the cloud storage 18b and transcodes (510) the video object based on the transcoding preferences. The codec portion notifies (512) the web server of the job status and the availability of the transcoded data and, upon completion, saves (514) the transcoded object (or objects) to cloud storage 18b and the updates (514) the status of the transcoded video object to the database 18a.

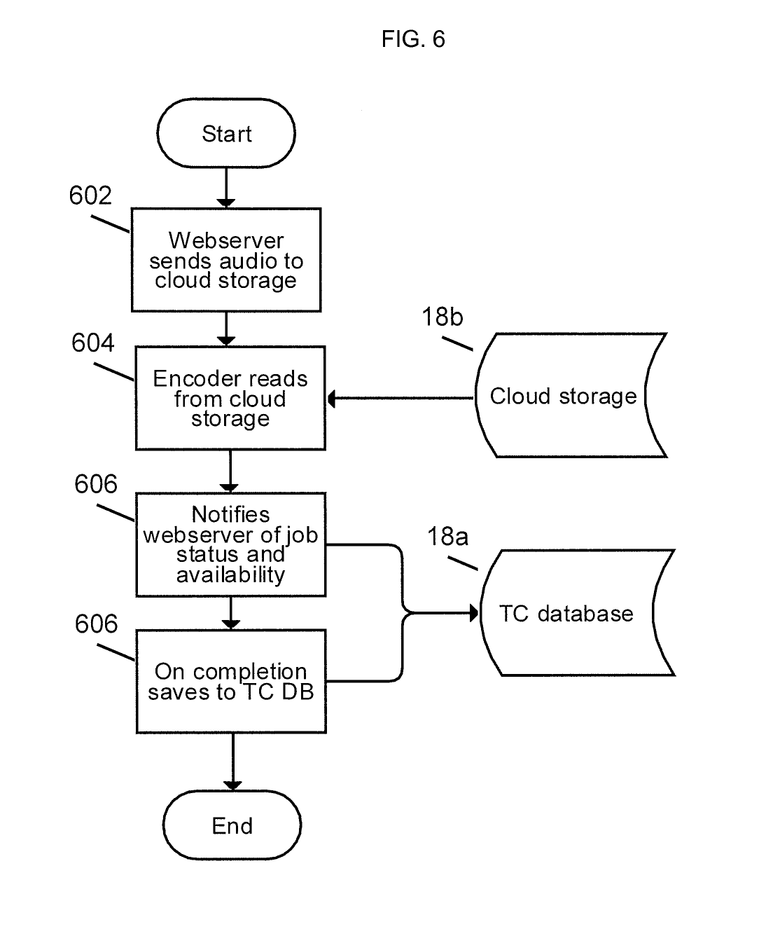

Referring to FIG. 6, according to one embodiment of the present invention, the web server 10 processes audio objects in a manner substantially similar to that in which video objects are processed. The webserver sends (602) audio to cloud storage 18b. The codec (or encoder) 10c then reads the stored audio object from the cloud storage 18b, and notifies the webserver of the status of the job and the availability of the processed audio file. The codec transcodes the audio in accordance with any transcoding preferences that may be set such as bitrate and output codec (e.g., MP3, AAC, Vorbis, WMA, FLAC, WAV, AIFF, etc.) Upon completion, the transcoded object (or objects) is saved (606) to the cloud storage 18b and the database 18a is updated (606) with the status of the transcoded object.

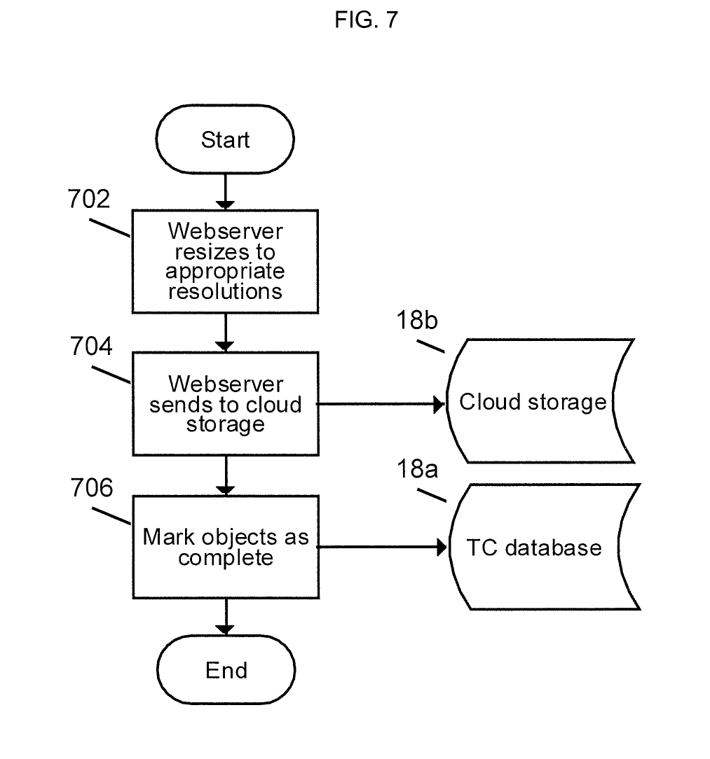

Referring to FIG. 7, according to one embodiment of the present invention, the webserver may process image objects by resizing (702) to appropriate resolutions (e.g., given the output resolution of the player), if necessary, and sends (704) the resized (or not resized) objects to cloud storage 18b. The webserver then marks (706) the processing of the objects as being complete in the database 18a.

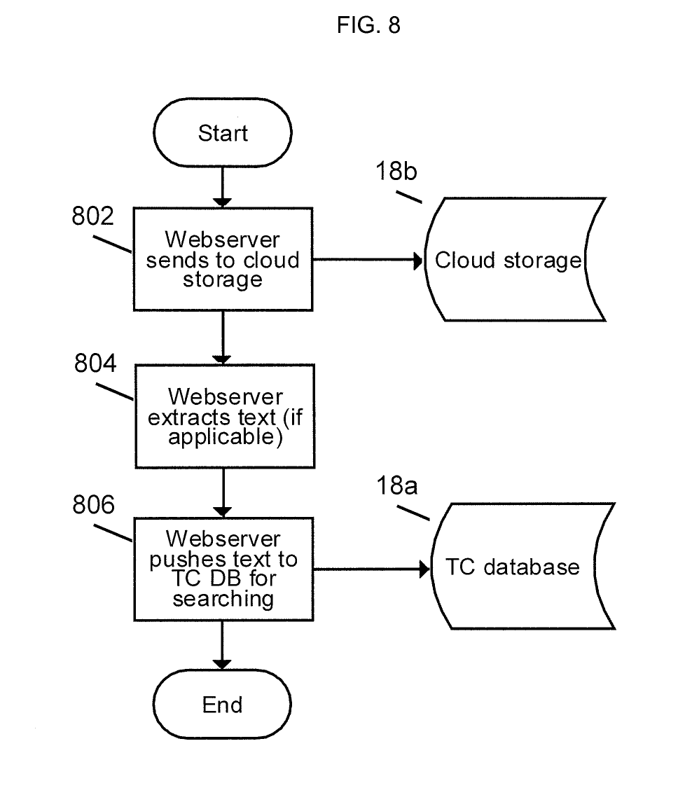

Referring to FIG. 8, according to one embodiment of the present invention, the webserver saves (802) miscellaneous other objects to the cloud storage 18b, extracts (804) any text or other metadata, if applicable, and pushes (806) the extracted text or metadata to the database 18a for searching.

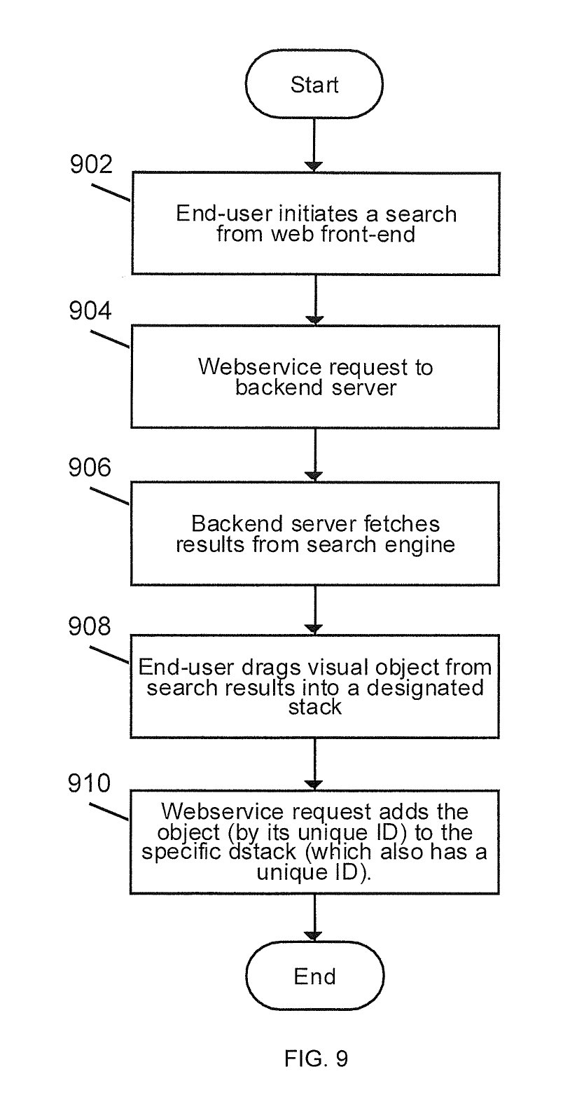

FIG. 9 is a flowchart illustrating a method for adding a media object to a stack according to one embodiment of the present invention. The front end 10b receives (902) a search request from an end user. The front end may then pass (904) the request to the back end server 10a. The backend server uses a search engine to search (906) the database 18a for results matching the query, and the resulting set of matching objects is presented to the user via the front end 10b. The end user may then drag objects from the search engine results into a designated “stack” of objects, thereby initiating a request to the server 10 to add the object to a stack (908). The front end 10b receives (910) the request from the end user to add the object to the specified stack and stores the addition in the database 18a. For example, the object and the stack may each have a unique identifier and the object's identifier may be added to a list associated with the stack's identifier.

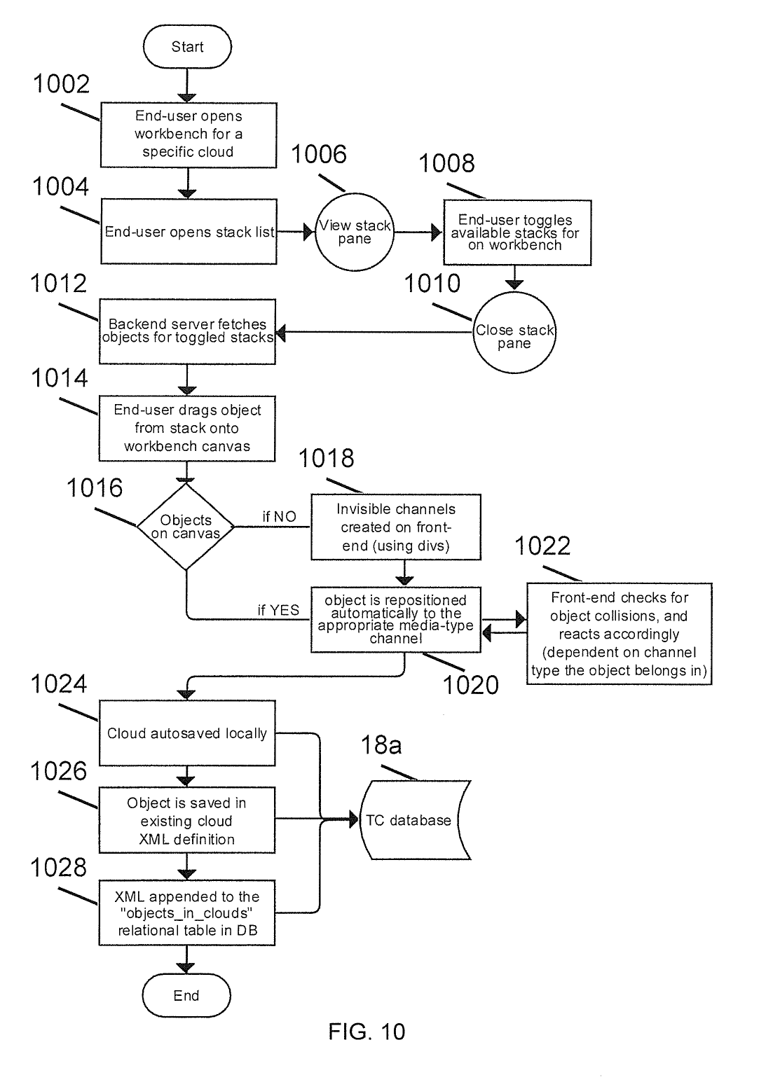

FIG. 10 is a flowchart illustrating a method for adding a media object from a stack onto a canvas according to one embodiment of the present invention. The end-user opens (1002) a workbench for a specific cloud (e.g., the front-end 10b receives a request to open the workbench and reads the workbench for the specific cloud (or “roughcut”) from the database 18a), then opens (1004) a list of stacks (e.g., and receives a request to show the list of stacks and reads the list of stacks from the database 18a). The web-front end then displays the stack pane so that it can be viewed by the end-user (1006). The end-user selects (or “toggles”) (1008) which stacks from the list of available stacks are to be shown on the workbench and then closes the stack pane (1010). The backend server 10a fetches (1012) objects for the toggled stacks to be displayed by the front end 10b. The end-user may then drag (1014) an object from a toggled stack onto the workbench canvas 30 (e.g., the front end 10b may receive a request from the user to place an object from the stack onto the canvas 30). When rendering the canvas 30, the front end 10b may determine (1016) whether or not there are objects on the canvas. If there are no objects on the canvas, then the front end 10b creates (1018) invisible “channels” (or objects) on the canvas (e.g., using HTML <div> tags). The objects are then positioned (1020) by the front end 10b in the appropriate media-type channel. The front end 10b also checks (1022) for collisions between objects and repositions objects to resolve the collisions (e.g., by shifting objects). Changes to the specific cloud (or “roughcut”) are then saved locally (1024) (e.g., to an in-browser cache or HTML5 local database) and then saved (1026) in the database 18a (e.g., as an XML or JSON definition of the cloud) and a table of objects currently being used in clouds (or “roughcuts”) is updated (1028) based on the objects used in the specific cloud.

According to one embodiment of the present invention, information about a cloud is stored in an XML format. This allows for a simple and lightweight description of the cloud, resulting in a relatively low bandwidth usage between the server 10 and the end user terminals 12. A sample XML document representing a cloud appears below:

```
<cues totalDuration=“8.681263739775115”
      open_stacks=“W251bGwsbnVsbCxudWxsLG51bGxd” left=“506” top=“101”
      width=“1680px” height=“771px” wb_zoom=“1.0999999999999999” >
  <videoCues>
    <cue id=“videoObject2” obj_id=“7517”
        left=“8.892144640336454” top=“0” bottom=“160”
        soffset=“0” eoffset=“1.9506483301923843”
        volume=“1” type=“image” >
      <adjustedStartTime>0</adjustedStartTime>
      <startTime>0</startTime>
      <type>image</type>
      <localStartTime>0</localStartTime>
      <volume>1</volume>
      <duration>1.9506483301923843</duration>
      <src>7517</src>
      <itemID>7517</itemID>
    </cue>
    <cue id=“videoObject0” obj_id=“3512”
        left=“10.842792970528839” top=“0” bottom=“160”
        soffset=“0” eoffset=“3.9” volume=“1” type=“image” >
      <adjustedStartTime>1.9506483301923843</adjustedStartTime>
      <startTime>1.9506483301923843</startTime>
      <type>image</type>
      <localStartTime>0</localStartTime>
      <volume>1</volume>
      <duration>3.9</duration>
      <src>3512</src>
      <itemID>3512</itemID>
    </cue>
    <cue id=“videoObject1” obj_id=“3513” left=“14.726516222533496”
        top=“0” bottom=“160” soffset=“0” eoffset=“1.8276344715316033”
        volume=“1” type=“image” >
      <adjustedStartTime>5.850648330192384</adjustedStartTime>
      <startTime>5.850648330192384</startTime>
      <type>image</type>
      <localStartTime>0</localStartTime>
      <volume>1</volume>
      <duration>1.8276344715316033</duration>
      <src>3513</src>
      <itemID>3513</itemID>
    </cue>
  </videoCues>
  <audioCues>
    <cue id=“audioObject0” obj_id=“4527” left=“10.842792970528839”
        top=“0” bottom=“871” soffset=“0” eoffset=“6.733333333333333”
        volume=“1” type=“audio” >
      <adjustedStartTime>1.9506483301923843</adjustedStartTime>
      <startTime>1.9506483301923843</startTime>
      <type>audio</type>
      <localStartTime>0</localStartTime>
      <volume>1</volume>
      <duration>6.733333333333333</duration>
      <src>4527</src>
      <itemID>4527</itemID>
    </cue>
  </audioCues>
  <textCues>
    <cue id=“textObject0” obj_id=“undefined” left=“10.842792970528839”
        top=“1.7046206128708223” bottom=“183” soffset=“0”
        eoffset=“0.640625” volume=“1” type=“text”
        styles=“eyJiYWNrZ3JvdW5kIjoiIiwiY29sb3IiOiIjRkZGRkZGIiwiZm9udCI
        6Ikdlb3JnaWEiLCJzaXplIjoiMjgiLCJwb3NfeCI6MC4xMjE1Mzg0NjE1Mzg0Nj
        E1NCwicG9zX3kiOjAuNTA5NTg5MDQxMDk1ODkwNCwiYWxpZ24iOiJjZW50ZXIif
        Q==” isMaster=“0” isSlave=“0” >
      <adjustedStartTime>1.9506483301923843</adjustedStartTime>
      <startTime>1.9506483301923843</startTime>
      <type>text</type>
      <duration>0.640625</duration>
      <src>Slam's%26nbsp%3BBeautiful(sort%26nbsp%3Bof)%26nbsp%3BCloud
      %26nbsp%3BRenderer%3Cbr%3E</src>
      <pos>
      <x>0.12153846153846154</x>
      <y>0.5095890410958904</y>
      </pos>
      <fontStyle>p%7Bfont-weight%3Anormal%3Bfont-style%3Anormal%3Btext-
decoration%3Anormal%3Btext-align%3Acenter%3Bcolor%3A%23FFFFFF%3Bfont-
family%3AGeorgia%3Bfont-size%3A28%3B%7D</fontStyle>
      <backgroundColor></backgroundColor>
    </cue>
    <cue id=“textObject1” obj_id=“undefined” left=“16.729884777866214”
        top=“1.2125651782276983” bottom=“211” soffset=“0”
        eoffset=“0.78125” volume=“1” type=“text”
        styles=“eyJiYWNrZ3JvdW5kIjoiIiwiY29sb3IiOiIjRkZGRkZGIiwiZm9udCI
        6Ikdlb3JnaWEiLCJzaXplIjoiMjgiLCJwb3NfeCI6MC43NDMwNzY5MjMwNzY5Mj
        MxLCJwb3NfeSI6MC44MjE5MTc4MDgyMTkxNzgsImFsaWduIjoiY2VudGVyIn0=”
        isMaster=“0” isSlave=“0” >
      <adjustedStartTime>7.83774013752976</adjustedStartTime>
      <startTime>7.83774013752976</startTime>
      <type>text</type>
      <duration>0.78125</duration>
      <src>the%26nbsp%3Bend</src>
      <pos>
      <x>0.7430769230769231</x>
      <y>0.821917808219178</y>
      </pos>
      <fontStyle>p%7Bfont-weight%3Anormal%3Bfont-style%3Anormal%3Btext-
decoration%3Anormal%3Btext-align%3Acenter%3Bcolor%3A%23FFFFFF%3Bfont-
family%3AGeorgia%3Bfont-size%3A28%3B%7D</fontStyle>
      <backgroundColor></backgroundColor>
    </cue>
  </textCues>
  <wildcardCues>
  </wildcardCues>
  <branchCues>
  </branchCues>
</cues>
```

In addition, in some embodiments of the present invention, objects in a cloud are also represented as XML. An XML document representing video objects in a cloud may be represented as shown below:

```
<videoCues>
  <cue>
    <type>(video or image)</type>
    <localStartTime>This is the initial seek into this specific video
(for when it's cropped)</localStartTime>
    <duration>End time - local start time(For cropping)</duration>
    <itemID>Object or Cloud ID</itemID>
    <startTime>This is the global start time(actual time in the general
timeline)</startTime>
    <adjustedStartTime>This is the global start time adjusted for
transitions such as crossfades((startTime - transDuration) for every
crossfade type transition run before this video)
    </adjustedStartTime>
    <volume>Max Volume level (0-1)</volume>
    <transition>
      <pre>
      <type>(fadein or crossfade)</type>
      <localStartTime>0</localStartTime>
      <duration>Duration</duration>
      </pre>
      <post>
      <type>(fadeout or crossfade)</type>
      <localStartTime>Seconds into the video that the transition should
play so basically video duration - transition duration</localStartTime>
      <duration>Duration</duration>
      </post>
    </transition>
    <mask>
      <type>(image or video)</type>
      <mode>Don't worry about this for now</mode>
      <itemID>Object ID</itemID>
    </mask>
  </cue>
</vidoeCues>
```

According to one embodiment of the present invention, audio objects in a cloud are represented as XML as described below:

```
<audioCues>
  <cue>
    <type>audio</type>
    <startTime>This is the global start time(actual time in the general
timeline)</startTime>
    <localStartTime>This is the initial seek into this specific video
(for when it's cropped)</localStartTime>
    <duration>End time - local start time(For cropping)</duration>
    <volume>Max Volume level (0-1)</volume>
    <itemID>Object or Cloud ID</itemID>
  </cue>
</audioCues>
```

According to one embodiment of the present invention, audio objects in a cloud are represented as XML as described below:

```
<textCues>
  <cue>
    <type>text</type>
    <startTime>This is the global start time(actual time in the general
timeline)</startTime>
    <duration>Duration</duration>
    <src>Encoded HTML text</src>
    <pos>
      These are in respect to the top-left corner
      <x>X-coord (ex 50)</x>
      <y>Y-coord (ex 233)</y>
    </pos>
    <fontStyle>Encoded CSS string(ex before encoding: p{
    font-family: Times New Roman, Times, _serif;
    font-size: 14;
    font-Style: italic;
    })
    (For all CSS values you can use, see
http://www.adobe.com/livedocs/flash/9.0/ActionScriptLangRefV3/flash/
text/StyleSheet.html)
    </fontStyle>
    <backgroundColor>Hex color(#000000)</backgroundColor>
  </cue>
</textcues>
```

Therefore, as can be seen above, according to some embodiments of the present invention, the location, start time, duration, and other characteristics of various media objects are described in the XML cues.

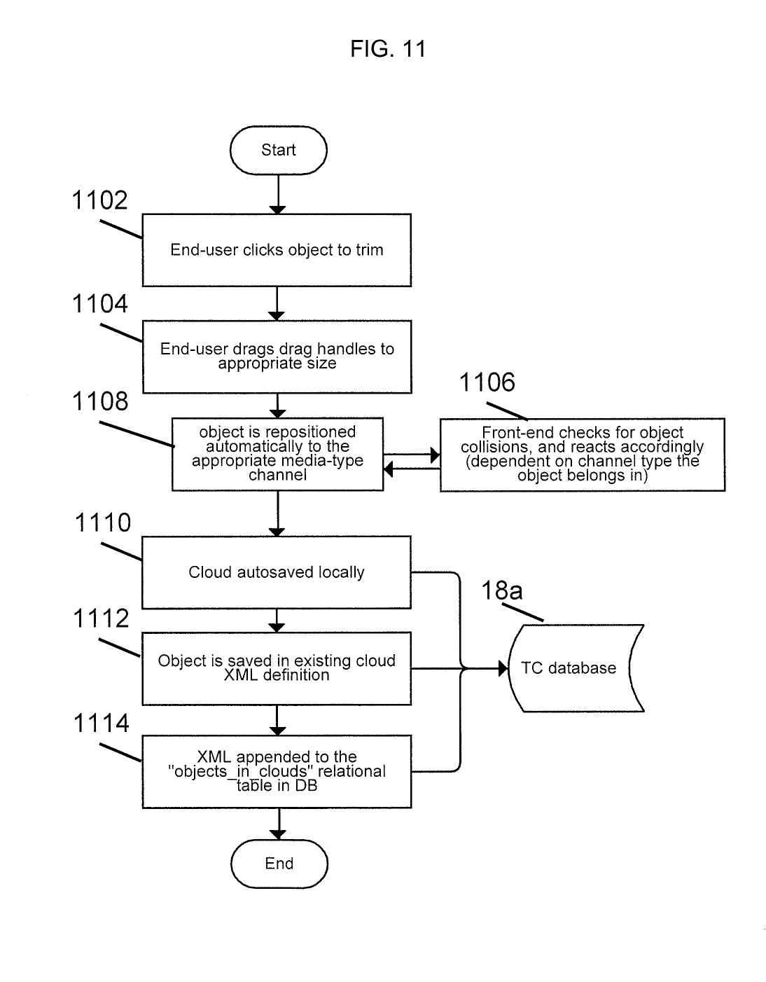

FIGS. 11, 12, and 13 are flowcharts illustrating methods of manipulating the length, position, and meta-data of objects. For example, the user 16 can drag the objects 34 along on x-axis of the canvas 30 to change the start time, pull on handles at the left and right sides of the objects 34 to adjust the duration and trim of the media objects, and click on a properties popup to view or modify other meta-data such as title, author, position in playback window, font color and size (of text objects).

FIG. 11 is a flowchart illustrating a method of trimming the length of time that an object appears in the presentation according to one embodiment of the present invention. An end-user selects an object to be trimmed (e.g., a client-side script or the front end 10b receives a request to select a particular object). The end-user then drags (1104) the handles of the object to a desired size. The object is then repositioned (1108) (e.g., by the front end 10b or by client-side scripts running on the end-user terminal 12a or 12e) to the appropriate media-type channel (e.g., video, audio, text, images, etc). The front-end may check (1106) for object collisions and reposition objects appropriately. The changes to the cloud may then be saved locally (1110), the changes to the object may be saved (1112) to the XML document representing the cloud, and the table in the database 18a may be updated (1114) accordingly.

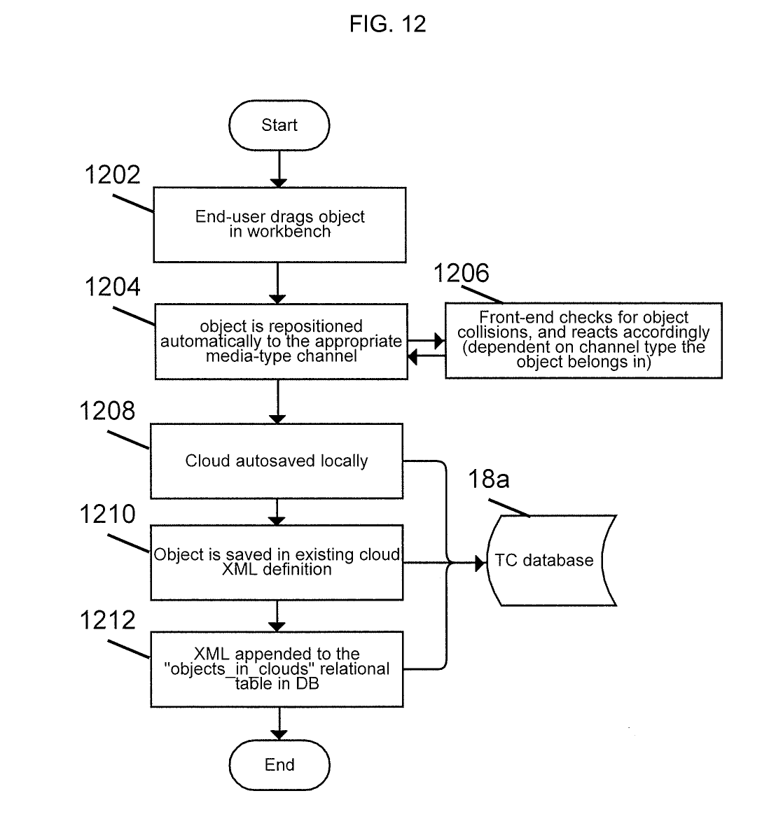

FIG. 12 is a flowchart illustrating a method of repositioning objects in a cloud according to one embodiment of the present invention, which is performed in a substantially similar manner to the trimming of an object as described above with respect to FIG. 11.

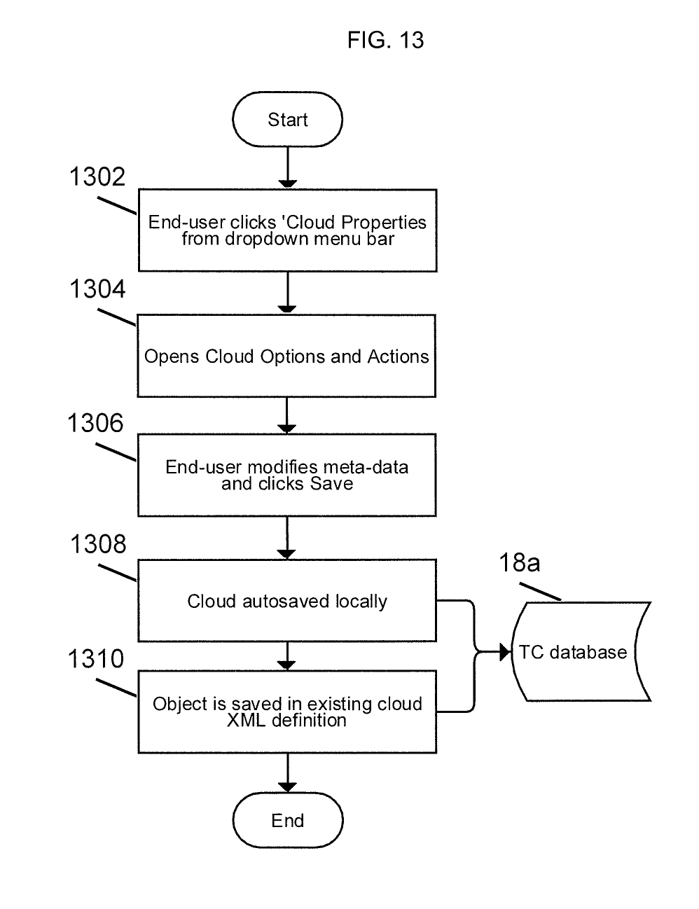

FIG. 13 is a flowchart illustrating a method of modifying metadata associated with cloud objects according to one embodiment of the present invention. The end-user clicks (1302) on a “cloud properties” function and the front end 10b displays (1304) cloud options and actions on the user interface, where the options, actions, and other metadata may be loaded from the database 18a. The end-user can modify (1306) the metadata, options, and other settings for the object and click a “save” button. The changes to the cloud are then saved (1308) locally in the browser and the existing cloud definition is updated (1310) with the changes, which are saved to the database 18a.

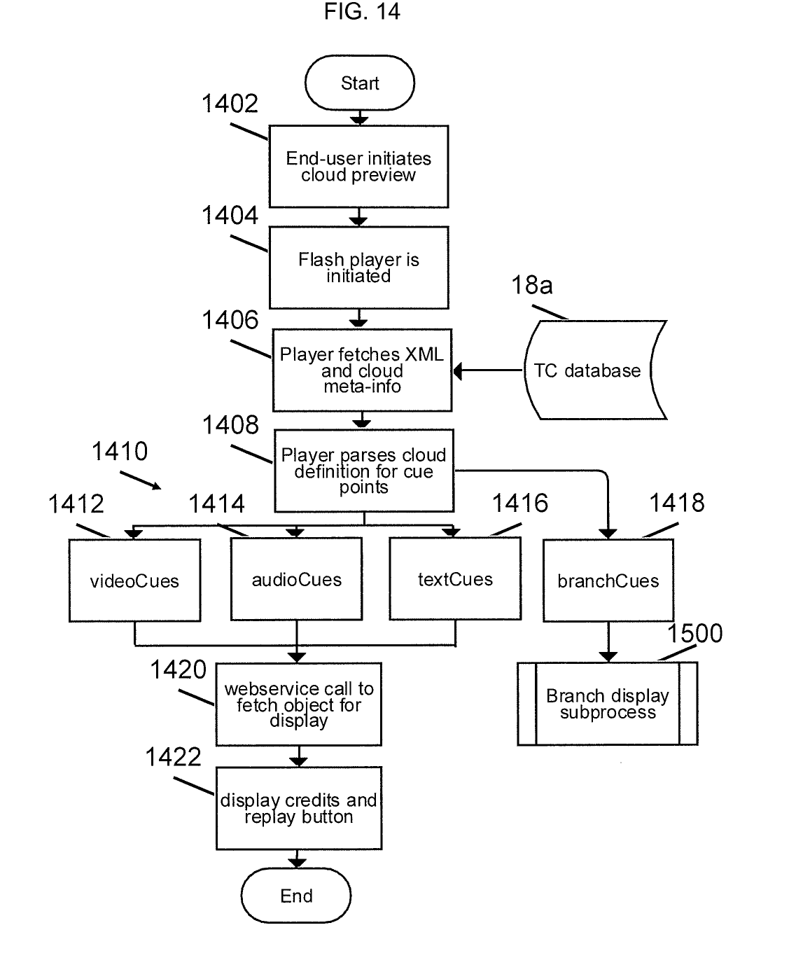

FIG. 14 is a flowchart illustrating a method of playing back a cloud according to one embodiment of the present invention. A cloud includes a sequence of videos, still images, text, and other media presented to a user 16 who is viewing the cloud (i.e., acting as a viewer) on a terminal device 12 over a network connection.

The end-user may initiate (1402) a preview (or playback of the cloud). A client-side player (e.g., an Adobe® Flash® based player) is initialized (1404). The client-side player fetches (1406) a document describing the cloud (e.g., an XML document) and other cloud meta-information from the database 18a. The client side player parses (1408) the cloud definition for cue points, which identify times at which particular items should be shown. These cues may include video cues (1412), audio cues (1414), text cues (1416), and branch cues (1418). During playback, requests (1420) are made to fetch objects for displays, in anticipation of the cues and the relative sizes of the objects. For example, requests for objects may be made in the order in which the objects are cued in the cloud, but may also take into account the relative sizes of the objects (e.g., a large video object may be requested before a smaller text object such that the video object is downloaded or buffered to be displayed at the right time during the playback of the cloud). After playback has completed, ending credits and a replay button are displayed (1422).

When presenting information using a cloud, it is sometimes useful to provide additional information to the viewer without disrupting the playback of the cloud. Therefore, in some embodiments, a cloud includes a branch node, which appears during the playback of the cloud. In some embodiments, these branch nodes prompt the viewer to select whether they want to view the branch and may be configured to cause the cloud to pause playback during the prompt or to continue playing while the prompt is displayed.

According to one embodiment of the present invention, when a branch cue 1418 is reached, the branch is displayed (1500). In one embodiment, branches appear in icon form at an upper portion of the playback window during playback. As branch nodes are reached, icons representing these branch nodes (e.g., thumbnails of the image or a frame from the video) are shown in the upper area so that the viewer can return to and view the branches at a later time without pausing the playback of the video.

When a user 16 activates a branch object, the object may be displayed by the viewer or by an external program (e.g., when displaying a document or spreadsheet). During the display of the content associated with a branch, the cloud can be configured to pause or continue its playback of the cloud.

In one embodiment, a branch can be added to a cloud by dragging a branch object onto the canvas. The branch object is initially blank, but a media object 34 such as a video, an audio clip, an image, or various documents can be dragged onto the branch, thereby associating the branch with content. In some embodiments, the branch may be associated with another cloud.

The representation of branch objects as XML in a cloud is described in more detail below:

```
<branchCues>
No gaps needed
  <cue>
    <type>branch</type>
    <hardStop>(0 or 1) Whether or not player should stop and prompt
user to take a branch</hardStop>
    <startTime>This is the global start time(actual time in the general
timeline)</startTime>
    <branchTitle>Title of branch</branchTitle>
    <desc>Description of branch</desc>
    <itemID>Object or Cloud ID (not required for links)</itemID>
    <src>Encoded URL (only required for links)</src>
    <mediaType>(audio,image,document,video,cloud,link) All except
document,link will play otherwise will prompt user to download the file
or open a new window/tab</mediaType>
  </cue>
</branchCues>
```

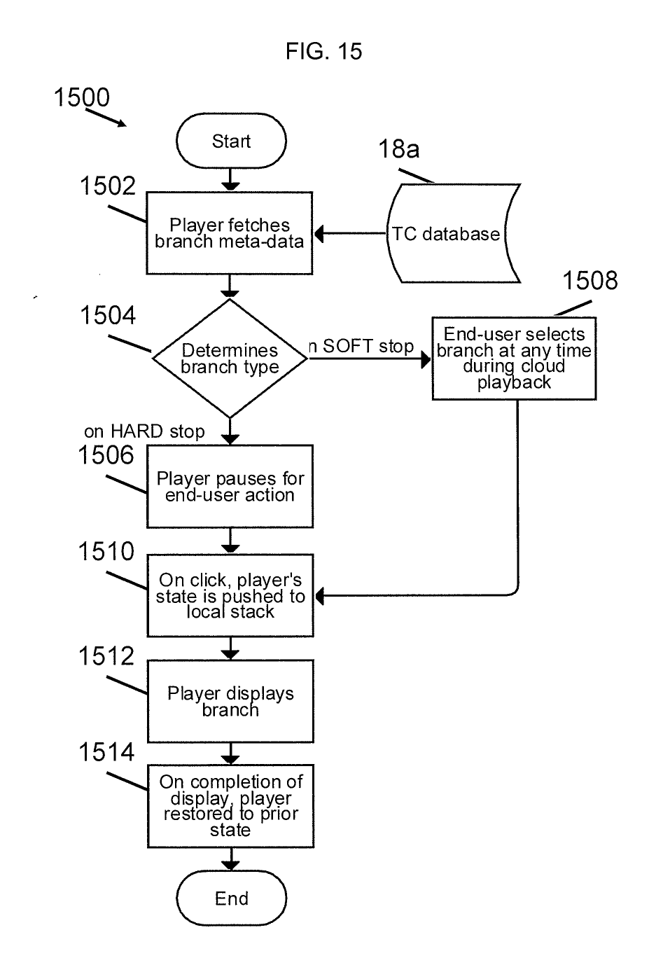

FIG. 15 is a flowchart illustrating the playback of a branch according to one embodiment of the present invention. The client-side player fetches (1502) the branch meta-data from the database 18a. The player then determines (1504) the branch type. If it is a “HARD stop” branch, then the players pauses (1506) playback to wait for the end user to take an action. If it is a “SOFT stop” branch, then playback continues and the end-user may select the branch at any time during playback. When a branch is activated (1510) (e.g., by a click), the player's state is saved to a local stack and the player begins playback of the branch in a manner substantially similar to the playback of a cloud as shown, for example, in FIG. 14.

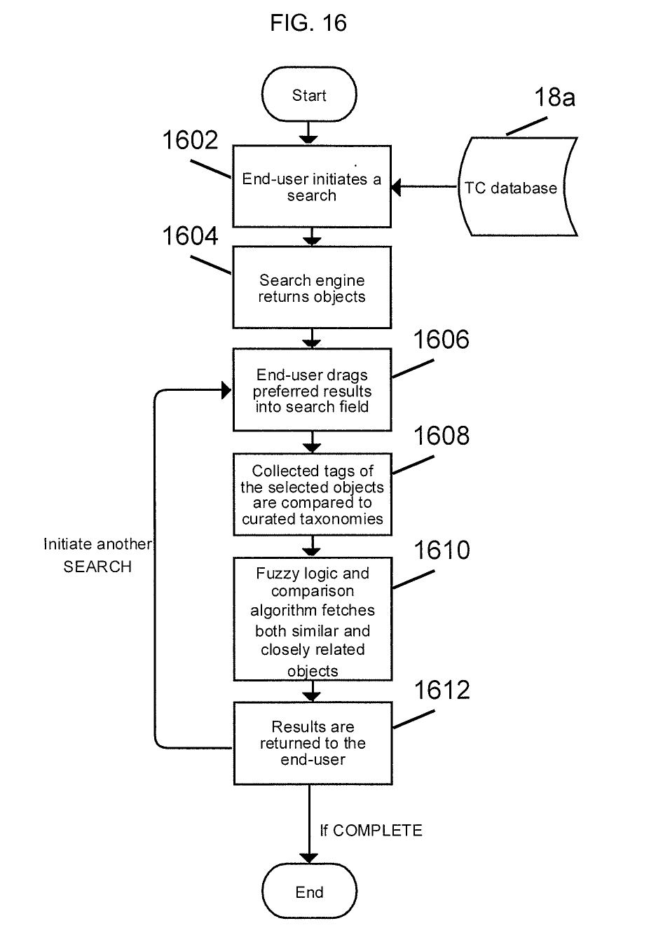

FIG. 16 is a flowchart illustrating taxonomical and recursive searching according to one embodiment of the present invention. An end-user may initiate a search (1602) by supplying a query, via the front end 10b, to the database 18a. The search engine (or the taxonomy processor 10e) of the server 10 returns (1604) one or more objects to the front end 10b and the objects are displayed at the end-user terminal 12. The end-user can then refine the search by selecting preferred results and dragging them into the search field (1606). Metadata tags associated with the selected preferred results are collected and compared (1608) to curated taxonomies (or classes) of objects in the database 18a and the cloud storage 18b. A fuzzy logic and comparison algorithm fetches (1610) similar and closely related objects from the database 18a and these results are returned to the user (1612).

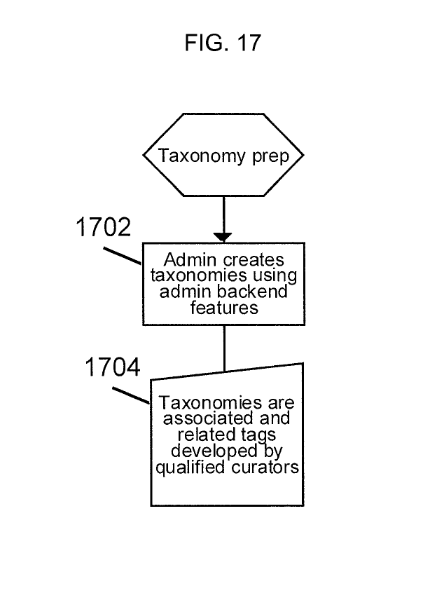

FIG. 17 is a flowchart illustrating a method of developing the curated taxonomies as described with respect to FIG. 16. An administrator may create (1702) taxonomies (e.g., classes or categories of objects) using various features exposed by the back end. Objects in the cloud storage database 18b are categorized and tagged by qualified curators (1704).

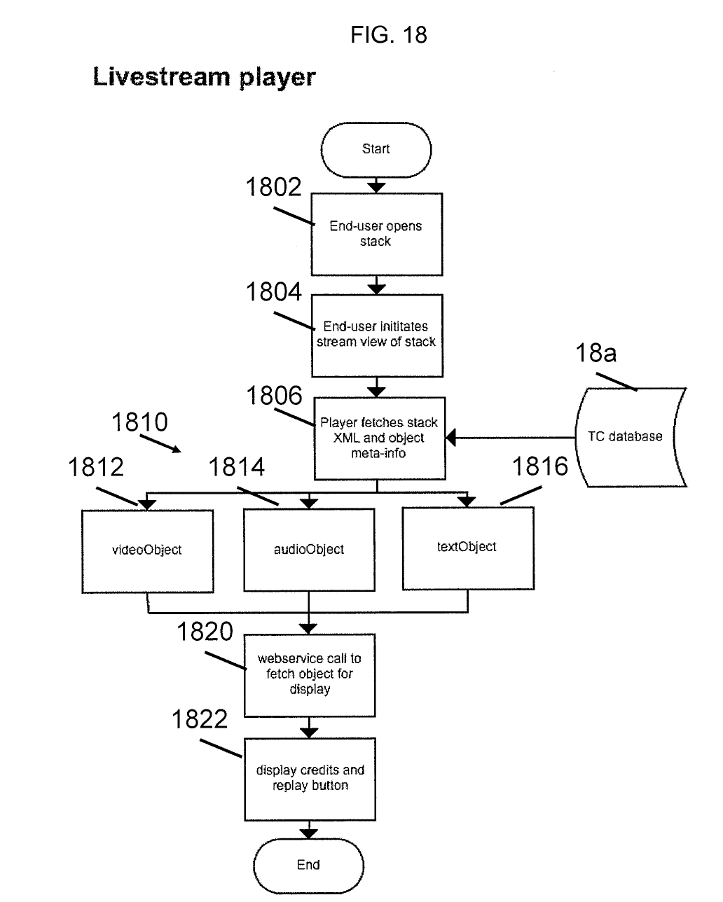

FIG. 18 is a flowchart illustrating a method of playing back the media stored in a stack using a live stream player according to another embodiment of the present invention. The live stream player allows instant display of any media stored in a stack in a sequential fashion. For example, a public stack, say of Arab Spring, can be displayed in real time without any manipulation by the user while other users may concurrently add new items to the stack.

The live stream player also has an option to play audio tracks in parallel with the display of other media types. With this option selected, the player parses the XML of the stack & creates two lists: one list of audio objects & a second list of all other objects. The player then parallel streams the two lists, so a live stream can have an audio track underneath the other, more visual files.

Referring to FIG. 18, an end-user first opens (1802) the stack. The end-user then initiates (1804) a stream view of the stack. The player fetches (1806) the XML document describing the stack from the database 18a. In a manner substantially similar to that described above in reference to FIG. 10, video objects, audio objects, and text objects are identified within the XML document and these objects are displayed in the player in the manner described in the metadata associated with the objects at the times specified in the cues associated with the objects of the playlist. The front end 10b fetches (1820) the objects for display from the cloud storage 18b. At the end of playback, credits and a replay button are displayed 1822.

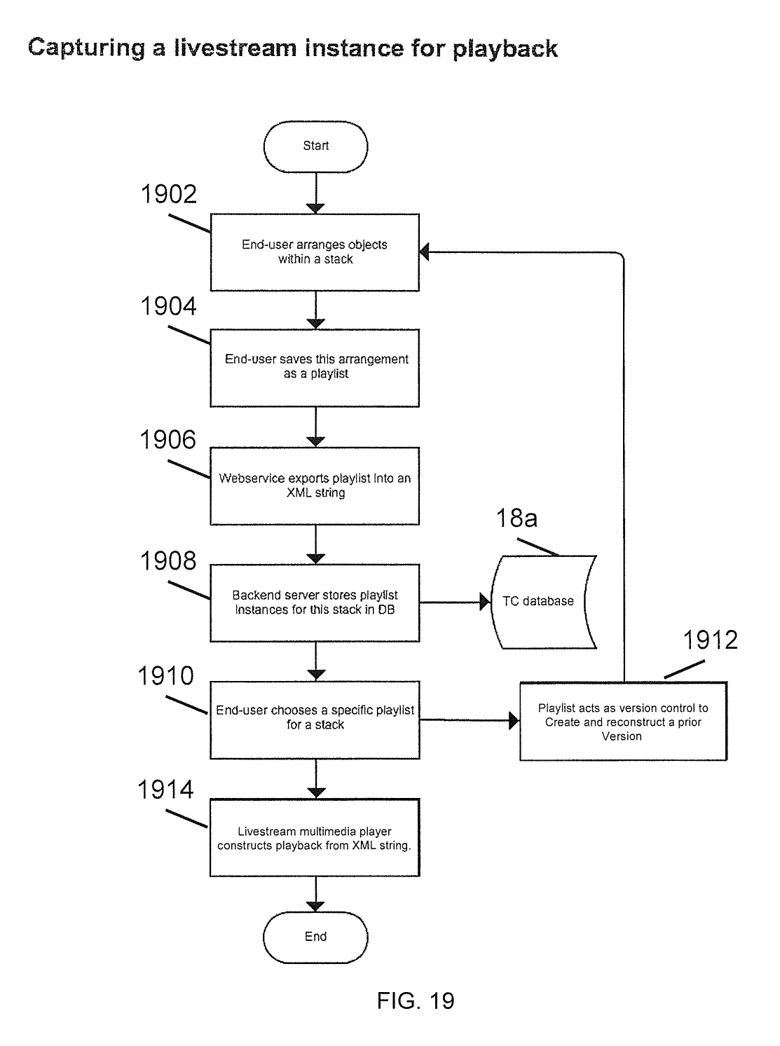

FIG. 19 is a flowchart illustrating the capture of a live stream for playback according to one embodiment of the present invention. A live stream instance is effectively a playlist selected by the user. This allows multiple users to rearrange the stack in a particular order & then have it play back as a live stream. This becomes important in the collaborative process as it allows different users to order the stack to reflect different understandings of the relationships of the various pieces. An instance also allows a user to capture a version, since it takes an XML snapshot of the stack. Once an instance is captured, other users can further manipulate the stack, including all operations such as additions, deletions, and rearrangements, all without affecting the captured stack instance.

The version control also allows the stack to be reconstructed from its state at a particular moment in time. The stack is not kept as a full data archive, but with the minimum number of data points necessary to reconstruct the stack (e.g., storing only the deltas or changes made between versions), so it is a very efficient storage of the stack instances.

Referring to FIG. 19, the end-user arranges (1902) objects within a stack. The end-user then saves (1904) the arrangement as a playlist. The server then exports (1906) the saved playlist as a document (e.g., an XML string). The backend server then stores (1908) the playlist instances for the stack in the database 18a. The end-user can then choose (1910) to load a specific playlist for a stack (e.g., the one the end-user just created). The selection of the playlist and can be used to create and reconstruct prior versions of the stack (1912). The player can then play back (1914) the constructed playlist.

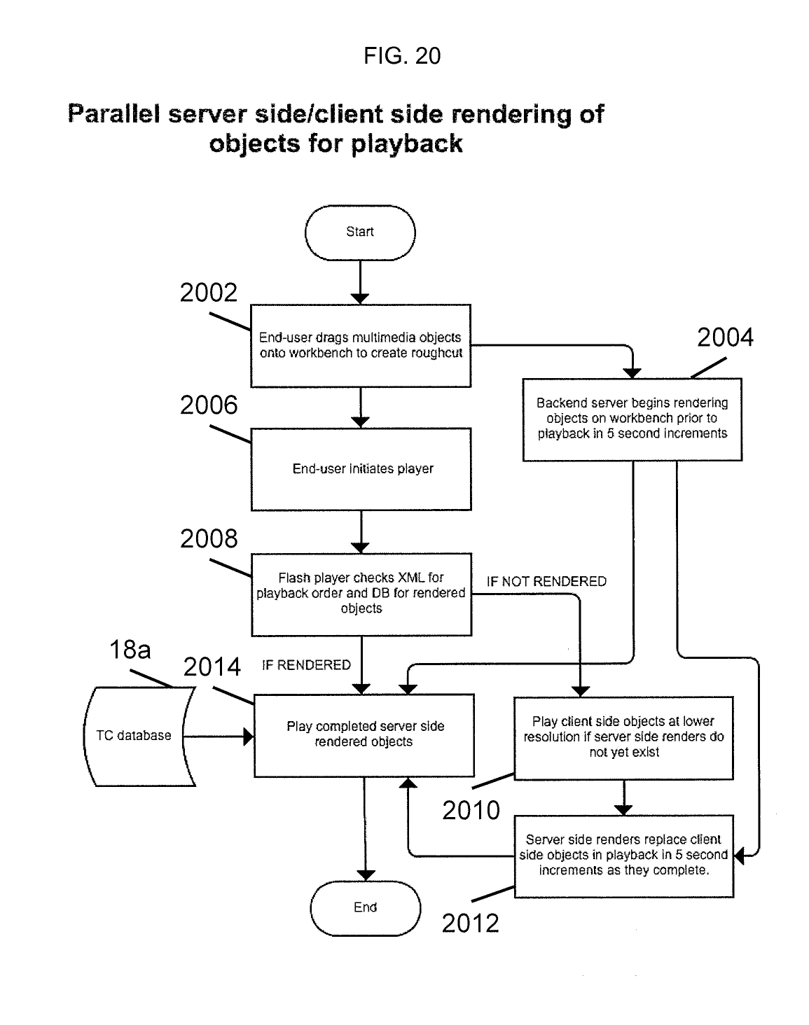

FIG. 20 is a flowchart illustrating a method of rendering objects for playback in parallel at both a client side and a server side. During the rendering process of videos in a cloud, rendering at the client-side (e.g., at client 12), generally resulted in lower resolution (or quality) but also resulted in a quicker response. Conversely, with server-side (e.g., at the server 10) rendering, higher resolutions and quality were available, but the display performance is highly dependent on bandwidth and can result in uneven playback.

As such, in some embodiments of the present invention, the player defaults to showing client side renders, while simultaneously polling for any portions of the video that have completed rendering on the server side. The server 10 is configured to encode (or transcode) video in blocks (e.g., 5 second blocks) and the client-side player pulls the server-rendered blocks as they become available to replace the lower-quality, client-side rendered blocks. The server side begins rendering the objects when the objects are dropped in place on the workbench and, as they finish rendering, the rendered blocks are cached on the server 10 (or, for example, in the cloud storage database 18b). In addition, objects within the system, with all recurrences referenced with an XML pointer, an object that has been rendered for playback becomes available for playback by other users.

Referring to FIG. 20, according to one embodiment of the present invention, the end-user drags (2002) objects onto a canvas 30 of a workbench to create a cloud (or “roughcut”), thereby sending a message to the server 10 indicating the addition of the object to the cloud. When the message is received by the server 10, the server determines whether the selected object has already been rendered (e.g., because it was previously used in another cloud by the same end-user or another end-user). If the object has not been rendered before, the backend server 10 (e.g., the codec portion 10c) begins rendering the objects in blocks (e.g., in five second increments) and storing the rendered blocks in the databases 18a and 18b.

Still referring to the embodiment of FIG. 20, when the user initiates (2006) the player (and as such, initiates the playback of the cloud), the player checks (2008) the description of the cloud (e.g., the XML description) for playback order and checks the databases 18a and 18b for rendered objects. If the requested objects have not been rendered, then the player plays (2010) lower-quality, client side rendered objects. As the server completes rendering of blocks of the objects being played, the completed blocks are sent to the client player where they replace (2012) the client side rendered blocks during playback. If and when rendering is complete, the client side player plays (2014) the server side rendered objects read from the database 18a (and/or the cloud storage 18b).

In practice, the parallel rendering means that, as a user is building a rough cut and playing it back during the process, the resolution of the played-back video may initially be at a lower resolution (because client side rendered blocks are being shown) and may later increase as the server side renders complete. By the end of the build process, the playback is at improved smoothness and at a higher playback quality in accordance with the available bandwidth.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

For example, access to various media objects can be controlled based on user permission levels. For example, a first user and a second user viewing the same cloud may see different media objects based on their permission levels. For example, a branch node having permissions restricted to the second user would only be displayed to the second user while the first user would not be shown the branch during playback.

What is claimed is:

1. A system for creating and playing a multimedia presentation, the system comprising:
a database;
a data store; and
a server connected to the database and the data store, the server being configured to:
store a plurality of media objects in the data store, each of the media objects being associated with a media object identifier of a plurality of media object identifiers, each media object identifier being unique;
store a plurality of stacks in the database, each of the stacks comprising a set of one or more media object identifiers selected from the plurality of media object identifiers;
store a presentation description of the multimedia presentation in the database, the presentation description comprising a set of one or more media object identifiers selected from the plurality of media object identifiers, each media object identifier of the set of one or more media object identifiers being associated with metadata, the metadata comprising timing and position information;
receive user inputs related to timing and position of the media objects associated with the multimedia presentation, the user inputs being received over a network connection; and
store the received user inputs in the presentation description of the multimedia presentation.

2. The system of claim 1, wherein the server is further configured to:
receive a request to play the multimedia presentation over the network connection;
retrieve the presentation description of the multimedia presentation from the database;
retrieve, from the data store, the media objects associated with the media object identifiers in the set of one or more media object identifiers associated with the presentation description; and
transmit, over the network connection, the plurality of retrieved media objects.

3. The system of claim 2, wherein the server is further configured to:
receive a request to add a media object identifier from a stack of the stacks to the multimedia presentation;
transcode a portion of a media object associated with the media object identifier; and
transmit the transcoded portion of the media object over the network connection when the transcoding is complete.

4. The system of claim 3, wherein the system further comprises a client connected to the server over the network connection, the client comprising a network interface, a processor, and a display, the client being configured to:
receive the plurality of retrieved media objects over the network connection;
transcode the portion of the media object associated with the media object identifier when the transcoding of the portion of the media object on the server is incomplete; and
display the retrieved media objects and the transcoded portion of the media object on the display.

5. The system of claim 1, wherein the presentation description further comprises a branch description associated with a branch, the branch description comprising a branch set of one or more media object identifiers selected from the plurality of media object identifiers, each media object identifier of the branch set of one or more media object identifiers being associated with metadata, the metadata comprising timing and position information, and
wherein the server is further configured to:
receive a request to play a branch;
retrieve, from the data store, the media objects associated with the media object identifiers in the branch set of one or more media object identifiers associated with the branch description; and
transmit, over the network connection, the plurality of retrieved media objects associated with the branch.

6. The system of claim 1, wherein the server is further configured to:
store one or more playlists associated with a stack of the stacks in the database, each of the playlists comprising a list of one or more media object identifiers selected from the set of one or more media object identifiers associated with the stack;
receive a request to play a playlist of the playlists over the network connection;
retrieve the requested playlist from the database;
retrieve, from the data store, a plurality of media objects associated with the media object identifiers in the list of one or more media object identifiers of the requested playlist; and
transmit, over the network connection, the plurality of retrieved media objects.

7. A method of authoring a multimedia presentation, the method comprising:
receiving a command, over a network connection, to add a first media object having a first start time to the presentation, the first media object being stored in a data store;
storing a first start time and an identifier of the first media object in a presentation description of the multimedia presentation, the presentation description being stored in a database;
receiving a command, over the network connection, to add a second media object having a second start time to the presentation, the second media object being stored in the data store; and
storing a second start time and an identifier of the second media object in the presentation description.

8. The method of claim 7, further comprising:
receiving a command, over the network connection, to adjust a length of the first media object; and
storing an adjusted stop time of the first media object in the presentation description.

9. The method of claim 7, further comprising:
receiving a request to play the multimedia presentation over the network connection;
retrieving the presentation description of the multimedia presentation from the database;
retrieving, from the data store, the first media object and the second media object; and
transmitting, over the network connection, the first media object and the second media object.

10. The method of claim 9, the method further comprising:
storing a plurality of stacks in the database, each of the stacks comprising a set of media object identifiers;
receiving a request to add a third media object identifier from a stack of the stacks to the multimedia presentation;
transcoding a portion of a third media object associated with the third media object identifier; and
transmitting the transcoded portion of the third media object when the transcoding is complete.

11. The method of claim 10, wherein the transcoding the portion of the third media object is performed by a server, the method further comprising:
transcoding, at a client coupled to the server, the portion of the third media object if the transcoding of the portion of the third media object by the server is incomplete;
receiving, at the client, the transcoded portion of the third media object from the server if the transcoding of the portion of the third media object by the server is complete; and
displaying the transcoded portion of the third media object.

12. The method of claim 7, wherein the presentation description further comprises a branch description associated with a branch, the method further comprising:
receiving a request to display a branch;
retrieving, from the data store, a branch media object listed in the branch description; and
transmitting the retriever branch media object over the network connection.

13. The method of claim 7, the method further comprising:
storing a plurality of stacks in the database, each of the stacks comprising a set of media object identifiers;
storing one or more playlists associated with a stack of the stacks, each of the playlists comprising a list of one or more media object identifiers selected from the set of one or more media object identifiers associated with the stack;
receiving a request to play a playlist of the playlists over the network connection;
retrieving the requested playlist from the database;
retrieving, from the data store, a plurality of media objects associated with the media object identifiers in the list of one or more media object identifiers of the requested playlist; and
transmitting, over the network connection, the plurality of retrieved media objects.

14. A method of playing back a multimedia presentation, the method comprising:
receiving, from a server, a presentation description of a multimedia presentation associated with a first media object and a second media object, the second media object having a start time later than the first media object;
requesting a first media object;
receiving and playing back the first media object; and
requesting the second media object after the start of the playing back of the first media object and before the start time of the second media object.

15. The method of claim 14, wherein the presentation description further comprises a branch object, the branch object being associated with a branch description comprising a reference to a third media object, the method further comprising:
receiving a presentation description of a multimedia presentation associated with a first media object, a second media object, and a branch object, the second media object being associated with the branch object and the branch object having a start time later than and during the playing back of the first media object;
requesting the first media object from a server;
receiving and playing back the first media object; and
at the start time of the branch object, displaying a control configured to allow a user to display the second media object.

16. The method of claim 15, further comprising:
receiving a command via the control to display the second media object;
pausing the playing back of the multimedia presentation; and
playing back the second media object.

17. The method of claim 15, further comprising:
adding a third media object to the multimedia presentation;
initiating playback of the multimedia presentation;
determining whether a portion of the third media object has been transcoded by a server;
transcoding a portion of the third media object if the transcoding of the portion of the third media object by the server is incomplete;
receiving the transcoded portion of the third media object from the server if the transcoding the portion of the third media object by the server is complete; and
displaying the transcoded portion of the third media object.

18. The method of claim 14, further comprising:
selecting a stack from a plurality of stacks stored in a database, each of the stacks comprising a set of media object identifiers;
selecting one or more media object identifiers from the set of media object identifiers of the selected stack;
adding the selected one or more media object identifiers to a playlist, each of the object identifiers being associated with a start time in the playlist; and
saving the playlist to the database.

19. The method of claim 18, further comprising:
requesting one or more media objects corresponding to the one or more media object identifiers of the playlist; and
receiving a plurality of media objects associated with the media object identifiers of the requested playlist.

20. The method of claim 18, further comprising:
loading the playlist;
modifying a start time of an object within the playlist; and
saving the modified playlist.
